(19) United States
(12) Patent Application Publication
(10) Pub. No.: US 2008/0239119 A1
(43) Pub. Date: Oct. 2, 2008

(54) IMAGE CAPTURING SYSTEM AND TECHNIQUE

(76) Inventor: Olivier Patrick Boireau, Los Altos, CA (US)

Correspondence Address: SHEMWELL MAHAMEDI LLP, 4880 STEVENS CREEK BOULEVARD, SUITE 201, SAN JOSE, CA, 95129, US

(21) Appl. No.: 11/694,946

(22) Filed: Mar. 31, 2007

(51) Int. Cl. H04N 9/04

(52) U.S. Cl. 348/282; 348/E09.002

(57) ABSTRACT

An image-capturing device includes a lens, a grid of light-sensitive elements, a sampling mechanism, and an image generation module. The lens is configured to be triggerable to open for a given duration. The grid is positioned so that when the lens is open, light is cast onto the grid. Each element of the grid is configured to provide a charge response to light. The sampling mechanism is coupled to the grid to repeatedly sample the grid during the duration by detecting whether the charge response of individual elements that comprise the grid exceeds a designated threshold level. The sampling mechanism records information that is indicative of a time in the duration in which the charge response of individual elements exceeds the designated threshold level. The image creation module generates an image corresponding to the scene using the information recorded by the sampling mechanism.

### TECHNICAL FIELD

The disclosed embodiments relate generally to the field of image capturing system and technique.

### BACKGROUND

Conventional camera technology rely on photo-capacitors that develop charge in response to receiving light. Such photo-capacitors are typically tied or used in conjunction with color filters that make the individual element sensitive to light from a particular range in the spectrum. Each photo-capacitor develops a voltage from exposure to light, and the voltage is a function of the intensity of light captured by that photo-capacitor. Often, voltage from individual photo-capacitors is used to interpret a value for that photo-capacitor. This value reflects the intensity of light captured by the corresponding photo-capacitor. Typically, the voltage is converted into a digital value by an analog-digital converter.

By using voltage values from the photo-capacitors, conventional techniques have some limitation in the range of light intensity that can be captured on one image. When exposed to light, photo-capacitors develop charge at a rate that is dependent on the intensity of the light being received. For this reason, photo-capacitors that capture light from a bright object develop charge more quickly than those photo-capacitors that capture light from a dark object. When a bright object is present in a picture that has otherwise normal or less bright surrounding objects, conventional approaches provide that the camera must either limit the exposure of light to capture the bright object or overexpose the bright object to capture the surrounding objects. Often, the camera captures the bright object and the remainder of the picture is dark.

Additionally, cameras typically require use of analog-digital converters in order to convert voltage values from photo-capacitors. Such converters are susceptible to noise, and add intricacies and cost to the device.

### BRIEF DESCRIPTION OF THE DRAWINGS

FIG. 1 illustrates an image capturing system, according to an embodiment of the invention.

FIG. 2 illustrates a technique for capturing images using time-based state information about individual elements of a grid, under an embodiment of the invention.

FIG. 3 illustrates the performance of processes in a time line or sequence of events, according to one or more embodiments of the invention.

FIG. 4 illustrates an image capturing device or system, according to an embodiment of the invention.

FIG. 5 illustrates a structure for use in enabling individual light-sensitive elements to change state and to detect the change in state, according to an embodiment of the invention.

FIG. 6 is illustrates examples of how the intensity of light can alter the charge response of an individual photo-capacitor, such as described with one or more embodiments.

FIG. 7 illustrates matrices of values that may be recorded at each instance of sampling from when the shutter is opened to closed.

FIG. 8 is a graph illustrating the dynamic range of light intensity that can be captured using embodiments such as described above.

### DETAILED DESCRIPTION

Embodiments described herein provide an image capturing system, device and technique which use time-based information about the charge state of individual pixels of a pixel grid on which light is cast, in order to create a digital picture. In particular, embodiments described herein define the charge state of individual pixels based on a charge response to light exposure, when, for example, a camera shutter is opened. When an image is to be captured and light exposure is initiated (e.g. when the shutter is opened), the individual pixels that comprise the grid on which light is cast are repeatedly sampled to determine the instance, during the duration of light exposure (e.g. while the shutter is opened), when the state of each pixel changes. This state information about each pixel, including the instance when each pixel changed states, may then be compressed or otherwise correlated into pixel values from which an image can be created.

According to an embodiment, the charge state may be binary in nature, in that the state is one of the pixel providing or not providing a charge response that exceeds a designated threshold.

As embodiments described herein collect state information about individual pixels, one or more embodiments eliminate a need for an analog-to-digital converter. Rather, state information may be collected and used in digital form.

Moreover, one or more embodiments provide that the use of time-based state information enables an image capturing system to collect sufficient light from all objects in a scene so that the image displays all objects with brightness that is accurate. In particular, one or more embodiments enable a pixel grid to capture and reflect the brightness level from all objects in a scene, regardless of whether there is an object or portion of the scene that is significantly brighter than another portion. In this way, light reflected from each object in a scene may be captured without influence or affect of the brightness of other objects in the scene.

According to an embodiment, an image-capturing device includes a lens, a grid of light-sensitive elements, a sampling mechanism, and an image generation module. The lens is configured to be triggerable to open for a given duration. The grid is positioned so that when the lens is open, light is cast onto the grid. Each element of the grid is configured to provide a charge response to light. The sampling mechanism is coupled to the grid to repeatedly sample the grid during the duration by detecting whether the charge response of individual elements that comprise the grid exceeds a designated threshold level. The sampling mechanism records information that is indicative of a time in the duration in which the charge response of individual elements exceeds the designated threshold level. The image creation module generates an image corresponding to the scene using the information recorded by the sampling mechanism.

As used herein, the term “pixel” is intended to mean a light-sensitive element. A pixel may include or be in the form of a photo-capacitor.

Embodiments described herein may be implemented or used on any device equipped to capture images, including digital cameras and multi-functional devices, such as cellular phones and messaging devices that are equipped with cameras.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

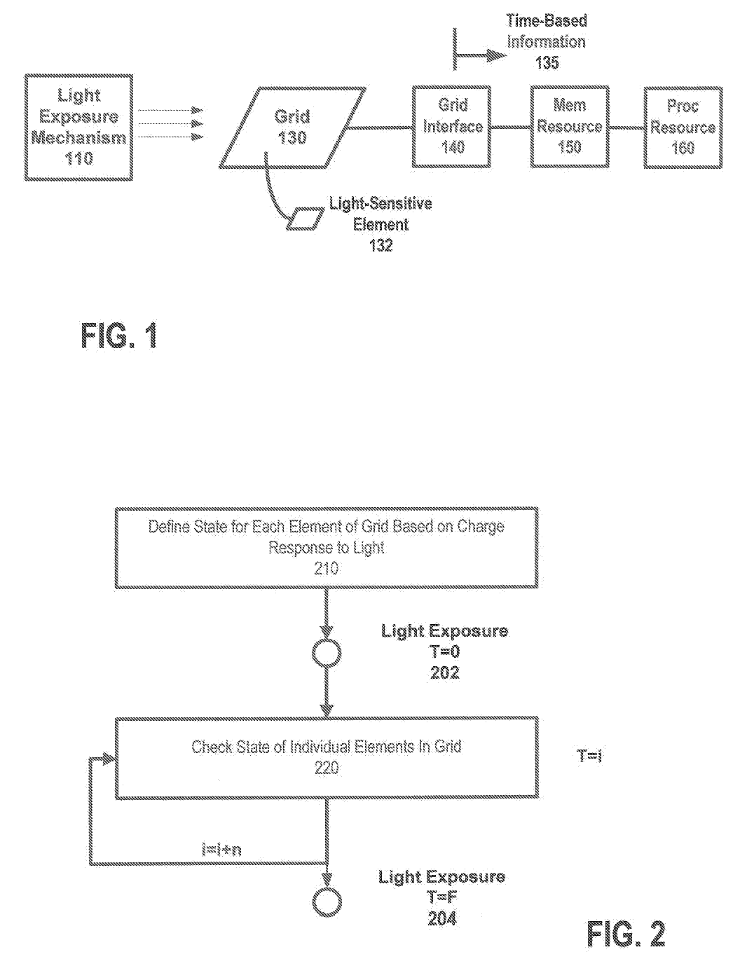

FIG. 1 illustrates an image capturing system, according to an embodiment of the invention. A system such as described in FIG. 1 may be implemented on, for example, a digital camera or a mobile computing device that is equipped to capture images. In an embodiment, a system 100 includes a light exposure mechanism 110, a grid 130 comprising a plurality of light-sensitive elements 132, a grid interface 140, memory resources 150, and processing resources 160. The light exposure mechanism 110 enables light to be cast onto the grid 130. An example of a light exposure mechanism 110 is a combination of a lens and shutter. An exposure duration is the amount of time in which the light exposure mechanism permits light to be cast onto the grid 130 (sometimes referred to as the “shutter speed”). Through use of a lens or other focusing mechanism, the light exposure mechanism may direct focused light from a scene onto the grid 130 during the exposure duration.

In an embodiment, the light-sensitive elements 132 of the grid 130 correspond to photo-capacitors. The elements 132 may be equipped with or coupled to filters to make them sensitive to color (red, green and blue). The elements 132 may sometimes be referred to as pixels.

During the exposure period, grid interface 140 interfaces with the grid 130 to determine time-based information about the charge response of individual elements 132 that comprise the grid. According to an embodiment, the grid interface 140 interfaces with individual elements 132 of the grid to determine information about when individual elements provide a charge response that meets or exceeds a designated threshold level. The charge response may correspond to an increase or decrease of charge stored or held by that element, resulting primarily from the individual elements 132 being exposed to light.

In an embodiment, the grid interface 140 includes hardware that scans the grid 130 repeatedly during the exposure duration. In one embodiment, the grid interface 140 includes a mechanism to compare a charge value of each element with a designated threshold value. With each scan of the grid 130, the grid interface 140 compares the determined charge value at the instance of the scan with the designated threshold value. The grid interface 140 can mark the instance when the element 132 is first scanned and determined to have a charge response that meets or exceeds the designated threshold level. The grid interface 140 may determine or return time-based, state information (“time-based information 135”) that reflects one or more of the following: (i) at each given instance when the shutter is opened and the grid is scanned, whether individual elements 132 that comprise the grid 130 had a charge response to the light exposure that met or exceeded a designated threshold level, or (ii) the particular instance that determined when each individual element 132 had a charge response to the light that met or exceeded the designated threshold level.

The time-based information 135 may be stored (temporarily or otherwise) with memory resources 150 and used by processing resources 160 to create a digital image 170. The memory resources 150 may correspond to buffers or other mediums in which information from the grid interface 140 is temporarily stored to permit the processing resources 160 to create the image.

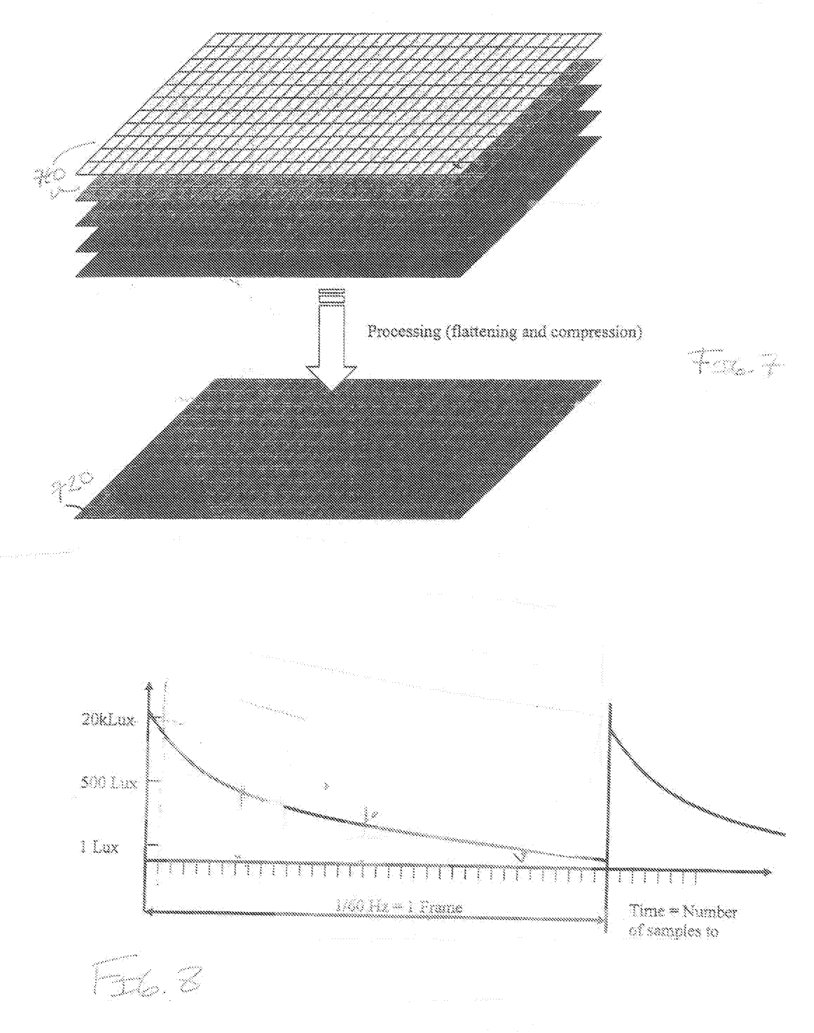

The processing resource 160 may perform any one of many algorithms to convert the time-based information 135 into the digital picture 170. In one embodiment, for example, the processing resource 160 may correlate an instance when each element 132 of the grid 130 had a charge response to a color and/or luminescent value for that element. For example, under one implementation, the algorithms performed by the processing resource 160 include determining a time t that marks when each element 132 changed state during the time of exposure. The processing resource 160 then correlates the time t with a value for that element. As individual elements 132 are equipped to absorb light from a designated spectrum (of red, green or blue), the value of each element 132 may reflect color and intensity or illuminosity. In another embodiment (such as shown by FIG. 7), the processing resource 160 records state information of each element 132 at each instance, and compresses or flattens the state information for each element in order to derive an element value. This value can then be correlated to color and/or light intensity.

FIG. 2 illustrates a technique for capturing images using time-based state information about individual elements of a grid, under an embodiment of the invention. A technique such as described with FIG. 2 may be implemented using, for example, a system such as described with FIG. 1. Reference is made to elements of FIG. 1 for illustrative purposes.

Initially, in a step 210, a state is defined for individual elements 132 (FIG. 1) that comprise the grid 130 (FIG. 1). In one embodiment, the state is defined by whether a change in a charge value carried by individual elements meets or exceeds a designated threshold level. This change may be referred to as the charge response. The state of the element 132 is then defined to change when the charge response meets or exceeds the designated threshold level.

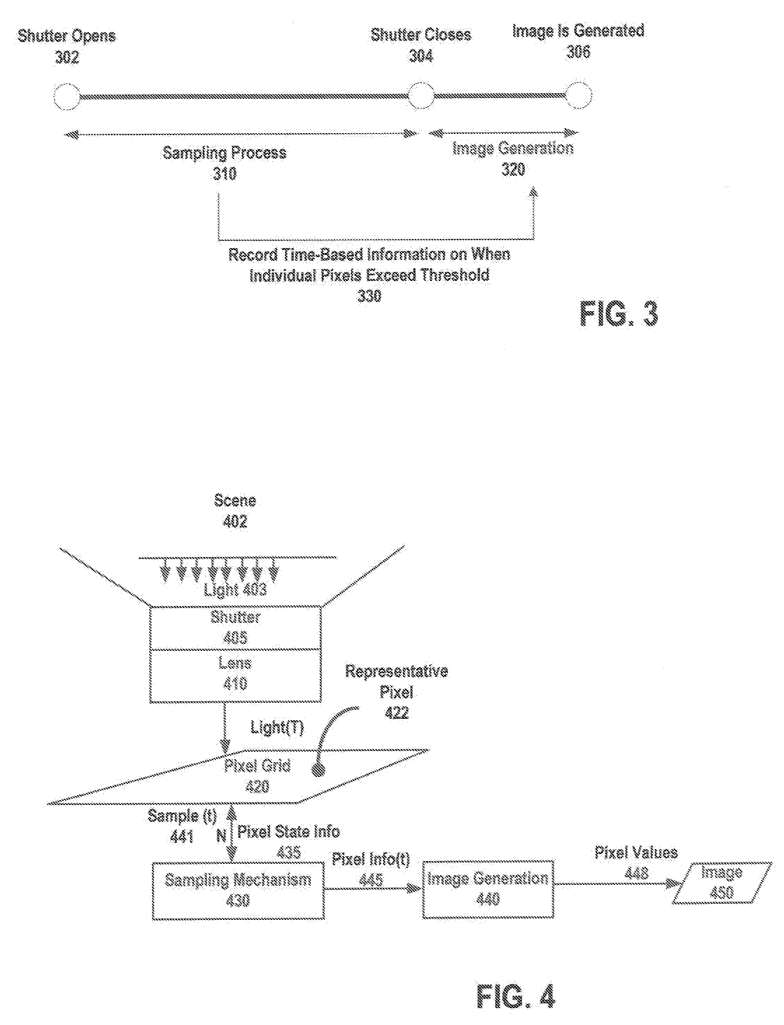

Event 202 marks the instance of time T=0, when light is cast onto the grid 130 from a scene of which the image is to be captured. This may correspond to a shutter of a camera device being opened. Subsequently, step 220 provides that the state of individual elements 132 of the grid 130 is checked repeatedly. In an embodiment such as described with FIG. 3 or FIG. 4, step 220 may be performed as part of a sampling process.

Step 220 may be performed until event 204, when the exposure to light is over, as marked by T=F (i.e. shutter closed). During the period of exposure, step 220 may be performed at each instance (i), and at a frequency of n. As described elsewhere in this application, the frequency in which step 220 is performed for each element in the duration between events 202, 204 may range in order of 10² to 10⁸. (although greater magnitudes are also possible).

In one embodiment, step 220 provides that the state of all elements 132 in the grid 130 is checked at each instance. In another embodiment, the state of some elements 132 in the grid is checked. For example, only those elements that have yet to change state may be checked. As part of step 220, information that is indicative of when each element 132 in the grid 130 changes state is recorded. This may correspond to recording the state of all elements in the grid at each instance (i), or recording for each element the value of i just before and/or after the state of that element changed.

Among other benefits, the conversion of the time-based information 135 to the digital picture 170 may be created in this way without the need for performing analog-to-digital conversions. Moreover, using time-based information 135, the image 170 may maintain and display accurate and fully lighted details of different objects that in actuality have significant disparity in brightness levels. Under conventional image capturing techniques, such images often result in pictures with bright objects making other objects in the image much darker than the objects actually were. This problem is avoided by an embodiment such as described with FIG. 1, in that the time-based information allows the luminescent levels of all elements (and thus objects) to be adequately recorded, even when one object in the picture is significantly brighter than another object.

FIG. 3 illustrates the performance of processes in a time line or sequence of events, according to one or more embodiments of the invention. Processes such as described with FIG. 3 may be performed using, for example, a system such as described with FIG. 1. For illustrative purposes, a description of the processes of FIG. 3 is made with reference is to elements of the system of FIG. 1.

One or more embodiments include a sampling process 310 and an image creation process 320. Under one or more embodiments, each process may be performed by a corresponding module. The sampling process 310 samples elements 132 of the grid 130 repeatedly in a duration marked by the event 332 of the shutter opening and the event 334 of the shutter closing. The sampling process 310 may perform the step of repeatedly checking the state of individual elements (as described by step 320 of FIG. 2) to determine when individual elements 132 of the grid 130 provide a charge response that meets or exceeds a designated threshold level. In an embodiment such as described by FIG. 1, the sampling process 310 is performed by the grid interface 140.

According to one embodiment, the output of the sampling process 310 is time-based state information 335. This information 335 records, at numerous instances between the open and close shutter events 332, 334, whether individual elements 132 have provided a charge response that meets or exceeds the designated threshold level. In one embodiment, the state of each element is recorded at each instance when the grid is sampled, regardless of whether or not that element has provided the requisite charge response. In another embodiment, the information 335 indicates the instance between the shutter events 332, 334 when individual elements are detected to provided the requisite charge response (i.e. the instance when the element 132 changed state).

The sampling process 310 passes the time-based state information 335 to the image creation process 320. In an embodiment such as shown, the image creation process 320 is performed after the event 334 of the shutter closing. At this instance, all elements 132 may be assumed to have provided the requisite charge response.

The image creation process 320 may follow and/or be performed concurrently with the sampling process 310. The image creation process 320 may generate a picture using the time-based information 335. The creation of the picture is signified by the event 336. In one embodiment, the image creation process 320 is aware of the range of color values and/or the amount of illuminance (which may be quantified by units of LUX or lumens/square meter) that can be recorded from each element 132 of the grid 130, and correlates the time-based information 335 of each element to a color and/or illuminance value for that element 132. For example, bright objects may trigger a relatively quick charge response from some elements 132 of the grid 130 that record reflected light from that object. In contrast, elements 132 that record light from darker objects in the same scene may require a relatively longer time to trigger the charge response. The time-based information 335 enables the image creation process 320 to determine the amount of light each element records from the scene, independent of the illuminance levels experienced by elements that record light reflected from bright or very bright objects.

In one embodiment, the sampling process 320 is configured to sample the grid 130 at a frequency that is sufficient to detect an instance before and after when a cluster of elements 132 provide the charge response that meets the designated threshold level when exposed to light that has an illuminance value in excess of some maximum value. Depending on the frequency of sampling, the maximum value can range, for example, from 15,000 LUX to 20,000 LUX. At the same time, other elements 132 may provide the charge response that meets the designated threshold level when exposed to light that has an illuminance value that is less than some minimum value. Depending on the length of the shutter speed, the minimum value may be in the range of 5-1000 LUX. With adequate sampling speed and sufficiently long shutter time, it is possible to record and adequately reflect light from two objects in a scene that have extreme disparity in illuminance. For example, a picture of a scene may contain both the sun and a person standing in shade. Under conventional approaches, a camera may generate the image to reflect the brightness from the sun, but the camera would also have to quicken the shutter speed to prevent the brightness of the sun from being whitewashed in the image. In this conventional approach, not enough light would be recorded from the darker objects to fully reflect the illuminance levels of those objects. The result is a picture that has the sun brightly shown, and the rest of the picture dark. In contrast, with the use of time-based information, the image creation process 320 can create an image that contains objects with disparate illuminance levels. This is because the elements 132 are being scanned to determine when they provide the requisite charge level. This allows bright objects and darker ones to be captured in an image together, where the brightness of each object in the image reflects the illuminance value of the corresponding image in the scene, and more specifically, the brightness of a darker object in the image is not limited by the presence of the bright object in the scene.

FIG. 4 illustrates an image capturing device or system, according to an embodiment of the invention. In FIG. 4, an image capturing device 400 may correspond to a system such as described with an embodiment FIG. 1, or to techniques, processes or modules such as described with an embodiment of FIG. 2 and FIG. 3.

According to an embodiment, the device 400 includes a shutter mechanism 405, a lens 410, a grid 420 comprising pixels 422, a sampling mechanism 430, and an image creation module 440. In operation, shutter mechanism 405 may expose the lens 410 to light 403 reflected from a scene 402. For a duration T (corresponding to when the shutter 405 is opened), this light may be captured on the grid 420. The pixels 422 may correspond to photo-capacitors that develop charge when exposed to light. Each pixel 422 may also include a color filter so that the pixel is predominantly sensitive to light from a specific range.

According to an embodiment, the sampling mechanism 430 repeatedly samples the grid 420 at individual instances t, where n*t=N, and n is the sample rate. With each instance of sampling the grid 420, the sampling mechanism 430 receives pixel state information 435, represented by psi(t). The pixel state information 435 includes information that is specific to individual pixels 422. As described with an embodiment of FIG. 2, the state of individual pixels 422 may be defined by the pixel's charge response to the light from the scene 402-specifically as to whether or not the pixel 422 has provided a charge response that meets or exceeds a designated threshold level. In one embodiment, the pixel information 435 represents (i) the state of individual pixels at each instance in which the sampling mechanism 430 performs a sampling operation 441, and/or (ii) for individual pixels 422, the instance t when the sampling mechanism 430 first determines that state of the individual pixel 422 has changed to one where the requisite charge response has been provided.

Time-based pixel information 445 is provided by the sampling mechanism 430 to the image creation module 440. The time-based pixel information 445 may correlate or be based on the pixel state information 435. For example, the pixel state information 435 may be filtered or processed to reflect timing of when individual pixels 422 changed state (as to charge response) when the shutter was open. The image creation module may correlate a pixel value 448 to each pixel based on the time-based information 445 for that pixel. The pixel value 448 may reflect a brightness or illuminance, as well as color (depending on the filter associated or included with the particular pixel). The result is the creation of the digital image 450.

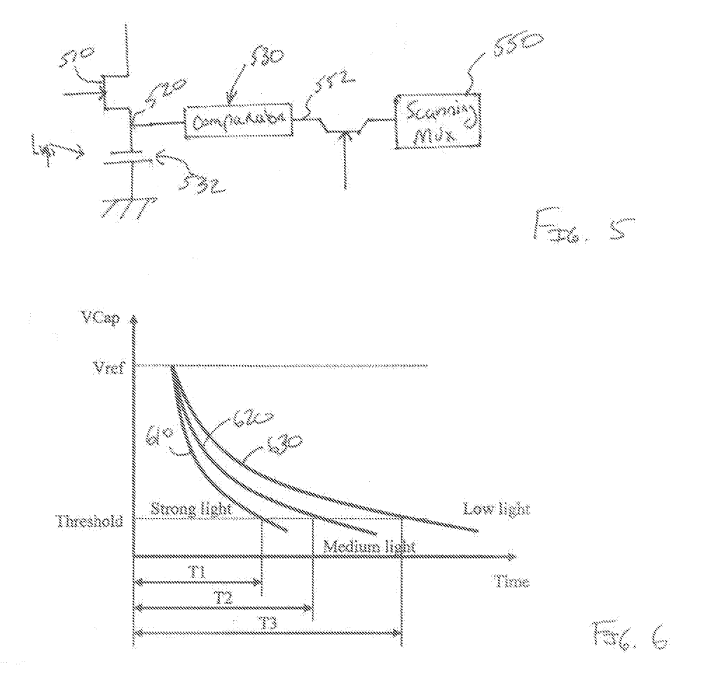

FIG. 5 illustrates a structure for use in enabling individual light-sensitive elements to change state and to detect the change in state, according to an embodiment of the invention. In an embodiment, a pixel or light-sensitive element 532 is a photo-capacitor that responds to light. A multiplexer 550 may form part of a sampling mechanism, and may couple to detect a charge or charge response from the element 532 during a duration of image capture.

The element 532 is provided a switch 510 that extends a reference voltage (Vref) to the element 532. The switch 510 may remain closed until the shutter is opened, in which case the switch 510 becomes open. In an implementation shown, Vref is greater than a designated threshold level. When the shutter and switch 510 are simultaneously opened, the element 532 is exposed to light and develops charge from light exposure. In an embodiment, the element 532 is arranged or configured with other elements to discharge Vref on node 520 when the switch 510 is opened and charge from light is developed. The opening of the switch 510 may coincide with the event of the shuttering opening or other exposure to light. In one embodiment, the element 532 is oriented or configured so that its rate of discharge at node 520 is dependent on its exposure to light. In this way, the element 532 discharges Vref at a rate that is dependent on the intensity of light received by that element. At some point, sufficient discharge of Vref occurs that the voltage at node 520 is less than or equal to a designated threshold value. At this point, the state of the element 532 may be deemed changed, as the charge response of the element meets or exceeds the designated threshold level.

In an embodiment, hardware resources such as shown by FIG. 5 may provide a substitute for a shutter. In one embodiment, Vref may be reset at the end of each image capture duration, so that each element 532 is reset for the next interval of image capture. The Vref reset may thus substitute for use of a shutter.

In an embodiment, a comparator 530 is used to detect the change in the state of the element 532 by detecting the voltage at the node 520. The comparator is provided on a signal line 552 that extends to the multiplexer 550. The comparator 530 may correspond to a switch that remains open until a voltage is encountered that is equal to or less than a designated threshold level. When the voltage from node 520 is equal to or less than the threshold level, the comparator 530 is closed. At each instance when sampling is performed, the multiplexer 550 records the value on the signal line 552, which is provided by the comparator being either open or closed. In this way, the comparator 530 reflects the state of the element 532 at any instance when the multiplexer 550 is used to sample the element 532.

FIG. 6 is illustrates examples of how the intensity of light can alter the charge response of an individual photo-capacitor, such as described with an embodiment of FIG. 5. FIG. 6 maps voltage at node 510 to time, starting at a time T=0, when a shutter open event occurs and voltage equals Vref. A first graph 610 illustrates the discharge rate of the element in the presence of strong light. A second graph 620 illustrates the discharge rate of the element 532 in the presence of medium light. A third graph 630 illustrates the discharge rate of the element in the presence of weak light. As shown by each graph, the voltage discharge from Vref may reach a designated threshold in a time period that is dependent on the intensity of light received by the element 532, with more intense light causing the element 532 to provide a faster charge response.

A structure such as described with an embodiment of FIG. 5 may be used to sample each light-sensitive element or pixel of a grid to determine the state of the elements individually. Individual elements may switch states at different instances in the duration when the shutter is opened. FIG. 7 illustrates matrices 710 of values that may be recorded at each instance of sampling from when the shutter is opened to closed. In each matrix 710, the state value of each element is a bit. After sampling is complete, the matrices may be compressed through processes of flattening and compression (by for, example, the image creation module 440 of FIG. 4) into one final matrix 720 where the value of each element is several bits or bytes. From this final value, an image may be created.

FIG. 8 is a graph illustrating the dynamic range of light intensity that can be captured using embodiments such as described above. The graph represents the intensity of light that can be captured over a duration of time that is provided by the shutter opening. The time T represents the duration provided by the shutter, and the values maxlux and minlux represent respective maximum and minimum light intensity values that can be captured on pixels of a device such as described with embodiments of the invention. The difference between maxlux and minlux represents the dynamic range of the image capture. For a shutter speed of 1/60 second, one or more embodiments may sample the pixel grid at a sufficient rate to enable maxlux to equal 20,000 LUX and minlux to equal 5 LUX. At these ranges, one picture may accurately represent the light intensity of both bright and dark objects from one scene. With these values of maxlux and minlux, dynamic range of the image capture may be in the range of 140 dB. This value compares favorably with convention camera technology that uses analog-digital converters and which have a dynamic range that is typically less than 70 dB. With greater sampling frequency and/or longer sampling period (longer shutter time), the dynamic range may be further increased.

Table 1 describes the capabilities and requirements of a device to have a specific dynamic range, according to an embodiment of the invention.

TABLE 1

| | | Sampling Frequency For | dB | Sampling |
|---|---|---|---|---|
| bit | level | Pixel Grid | Dynamic | Frequency For Individual Pixel |
| 0 | 1.00 | 60.00 | 1.76 | 61,440.00 |
| 1 | 2.00 | 120.00 | 7.78 | 122,880.00 |
| 2 | 4.00 | 240.00 | 13.8 | 245,760.00 |
| 3 | 8.00 | 480.00 | 19.82 | 491,520.00 |
| 4 | 16.00 | 960.00 | 25.84 | 983,040.00 |
| 5 | 32.00 | 1,920.00 | 31.86 | 1,966,080.00 |
| 6 | 64.00 | 3,840.00 | 37.88 | 3,932,160.00 |
| 7 | 128.00 | 7,680.00 | 43.9 | 7,864,320.00 |
| 8 | 256.00 | 15,360.00 | 49.92 | 15,728,640.00 |
| 9 | 512.00 | 30,720.00 | 55.94 | 31,457,280.00 |
| 10 | 1,024.00 | 61,440.00 | 61.96 | 62,914,560.00 |
| 11 | 2,048.00 | 122,880.00 | 67.98 | 125,829,120.00 |
| 12 | 4,096.00 | 245,760.00 | 74 | 251,658,240.00 |
| 13 | 8,192.00 | 491,520.00 | 80.02 | 503,316,480.00 |
| 14 | 16,384.00 | 983,040.00 | 86.04 | 1,006,632,960.00 |
| 15 | 32,768.00 | 1,966,080.00 | 92.06 | 2,013,265,920.00 |
| 16 | 65,536.00 | 3,932,160.00 | 98.08 | 4,026,531,840.00 |
| 17 | 131,072.00 | 7,864,320.00 | 104.1 | 8,053,063,680.00 |
| 18 | 262,144.00 | 15,728,640.00 | 110.12 | 16,106,127,360.00 |
| 19 | 524,288.00 | 31,457,280.00 | 116.14 | 32,212,254,720.00 |
| 20 | 1,048,576.00 | 62,914,560.00 | 122.16 | 64,424,509,440.00 |
| 21 | 2,097,152.00 | 125,829,120.00 | 128.18 | 128,849,018,880.00 |
| 22 | 4,194,304.00 | 251,658,240.00 | 134.2 | 257,698,037,760.00 |
| 23 | 8,388,608.00 | 503,316,480.00 | 140.22 | 515,396,075,520.00 |
| 24 | 16,777,216.00 | 1,006,632,960.00 | 146.24 | 1,030,792,151,040.00 |
| 25 | 33,554,432.00 | 2,013,265,920.00 | 152.26 | 2,061,584,302,080.00 |
| 26 | 67,108,864.00 | 4,026,531,840.00 | 158.28 | 4,123,168,604,160.00 |
| 27 | 134,217,728.00 | 8,053,063,680.00 | 164.3 | 8,246,337,208,320.00 |

Table-1 assumes a pixel grid size of 1024*1224, with an assumed shutter speed of 1/60 seconds. The first column of Table-1 correspond to the number of bits needed for a pixel bit value. The pixel bit value sets the amount of information that can be carried about a pixel. According to one or more embodiments described above, the state of each pixel is recorded at each instance that the pixel grid is sampled. The second column provides the number of possible values that may be determined from each pixel after processing, and equals 2ⁿ, where n is from the first column. The third column represents the pixel sampling frequency. In an embodiment, the pixel sampling frequency is limited by the pixel bit size, and is represented for a full second to provide normality in the analysis of the various values. The fifth column represents the master sampling frequency. The fourth column illustrates the dynamic range (dB) of light intensity (using light units such as LUX) that can be achieved using the sampling frequencies stated in a particular row.

With reference to Table-1, one or more embodiments enable the use of a 10-bit pixel value to have a dynamic range of light intensity that is just less than 63 dB, with a sampling frequency set by a master clock of less than 63 MHz. This dynamic range is comparable to conventional digital cameras, and requires only a 10-bit pixel value. A 16-bit pixel value may achieve a dynamic range of light intensity that is just under 99 dB, using a master sampling frequency of just over 1 GHz. However, Table-1 assumes that a single master buffer is used for the 1024*1224 size pixel grid. If the pixel grid is divided to use separate buffers, the master sampling frequency can be similarly reduced. Thus, additional buffers and hardware can compensate for the master sampling frequency.

In general, the maximum level of light intensity that can be captured on camera is about 20,000 LUX, while the darkest level of light intensity is in a range of 100 to 1000 LUX. The dynamic range of these two extremes is about 140 dB. According to embodiments described herein, and illustrated by Table-1, this dynamic range can be achieved by sampling individual pixels at 500 MHz, collecting 8388 matrices of the pixel grid in the shutter time ( 1/60 second), and using 23 bits to store each pixel value.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, the absence of describing combinations should not preclude the inventor from claiming rights to such combinations.

1. A device comprising:
a lens;
a grid comprising a plurality of light-sensitive elements, wherein each element is triggerable, for a duration in which an image is to be captured, to provide a charge response to light, and wherein the grid is positioned relative to the lens to receive light cast from a scene when the lens is opened;
a sampling mechanism that is coupled to the grid to repeatedly sample the grid during the duration by detecting whether the charge response of individual elements that comprise the grid exceeds a designated threshold level, and wherein the sampling mechanism records information that is indicative of a time in the duration in which the charge response of individual elements exceeds the designated threshold level; and
an image generation module that generates the image corresponding to the scene using the information recorded by the sampling mechanism.

2. The device of claim 1, wherein the sampling mechanism samples each element of the grid at a frequency that is of an order of 10⁴ or greater.

3. The device of claim 1, wherein the elements that comprise the grid include photo-capacitors that provide the charge response in response to receiving light cast from the scene.

4. The device of claim 3, wherein each element of the grid includes a filter provided with the photo-capacitor, wherein the filter filters that is not of a designated color spectrum from reaching the photo-capacitor.

5. The device of claim 1, wherein the image is generated without use of an analog-digital converter.

6. The device of claim 1, wherein the information recorded by the sampling mechanism includes a time in the duration in which individual elements that comprise the grid develop or discharge sufficient charge from exposure to light to exceed the designated threshold level.

7. The device of claim 1, wherein the information recorded by the sampling mechanism includes a state of each element of the grid at each instance that the grid is sampled in the duration, wherein the state of each element is defined by whether the element developed a charge response to the light from the scene that met or exceeded a designated threshold level.

8. The device of claim 7, wherein the information recorded by the sampling mechanism includes a state value for each element of the grid at each instance that the grid is sampled in the duration, and wherein the state value for each element is based on a determination as to whether that element developed or discharged sufficient charge to meet the designated threshold level.

9. The device of claim 1, wherein the sampling mechanism is configured to sample the grid at a frequency that is sufficient to enable the image creation module to create the image with a dynamic range of light intensity that is capable of being in the range of 90-100 dB.

10. The device of claim 1, wherein the sampling mechanism is configured to sample the grid at a frequency that is sufficient to enable the image creation module to create the image with a dynamic range of light intensity that is capable of being in the range of 130-140 dB.

11. A method for capturing an image from a scene, the method comprising:
receiving light on a grid that comprises a plurality of light-sensitive elements, wherein the light is received from a scene;
repeatedly sampling the grid, at a plurality of instances in a duration in which an image is to be captured, by detecting whether individual elements of the grid develop a charge response that exceeds a designated threshold level;
recording information that is indicative of the instance in which individual elements in the plurality of elements developed the charge response to meet or exceed the designated threshold level; and
using the recorded information to generate the image of the scene.

12. The method of claim 11, wherein recording information includes recording a state of each element at each instance in the duration, including at the instance when each element is detected to change its state, wherein the state is defined by whether the individual element developed the charge response to meet or exceed the designated threshold value.

13. The method of claim 12, wherein using the recorded information includes compressing the state of each element at each instance in order to generate the image.

14. The method of claim 11, wherein repeatedly sampling the grid includes repeatedly sampling individual elements that comprise the grid at a frequency of an order of 104 or greater.

15. The method of claim 11, wherein recording information includes marking a time in the duration in which individual elements that comprise the grid developed the charge response from exposure to light that meets or exceed the designated threshold level.

16. The method of claim 11, wherein recording information includes generating a matrix of values at each instance in the duration when the grid is sampled, wherein the matrix comprises a value for each element of the grid at the instance when the matrix is generated, and wherein the value for each element reflects a determination as to whether that element developed sufficient charge to exceed the designated threshold level.

17. The method of claim 11, wherein repeatedly sampling the grid includes sampling the grid a frequency that is sufficient to enable generation of the image with a dynamic range of light intensity that is capable of being in the range of 90-100 dB.

18. The method of claim 11, wherein repeatedly sampling the grid includes sampling the grid a frequency that is sufficient to enable generation of the image with a dynamic range of light intensity that is capable of being in the range of 130-140 dB.

19. The method of claim 11, wherein the designated threshold level is the same for all elements of the grid.

20. A system for capturing an image from a scene, the system comprising:
a lens;
a grid that comprises a plurality of elements, wherein the grid is positioned relative to the lens to receive light from a scene for a duration in which an image is to be captured;
means for repeatedly sampling the grid, at a plurality of instances in the duration, by detecting whether individual elements of the grid develop charge response that exceeds a designated threshold level; and
means for recording information that is indicative of the instance in which individual elements in the plurality of elements developed sufficient charge to exceed the designated threshold level; and
means for using the recorded information to generate the image of the scene.
